(19) United States
(12) Patent Application Publication
(10) Pub. No.: US 2026/0245957 A1
(43) Pub. Date: Aug. 20, 2026

(54) HIGH GREEN DENSITY CERAMICS FOR BATTERY

(71) Applicant: QUANTUMSCAPE BATTERY, INC., San Jose, CA (US)

(72) Inventors: Kim Van BERKEL, San Jose, CA (US); Patrick JEFFRIES, San Jose, CA (US)

(21) Appl. No.: 19/355,951

(22) Filed: Oct. 10, 2025

Related U.S. Application Data
(63) Continuation of application No. 17/792,107, filed on Jan. 15, 2021, now Pat. No. 12,469,876.
(60) Provisional application No. 62/961,611, filed on Jan. 15, 2020.

(51) Int. Cl. H01M 10/0562; C04B 35/622; C04B 35/626; C04B 41/00

(52) U.S. Cl. CPC H01M 10/0562; C04B 35/62218; C04B 35/6264; C04B 35/62655; C04B 35/6268; C04B 41/0072; C04B 2235/6025; C04B 2235/606; C04B 2235/608; C04B 2235/658; C04B 2235/77

(57) ABSTRACT

Set forth herein are processes and materials for making ceramic thin green tapes by casting ceramic source powders and precursor reactants, binders, and functional additives into unsintered thin green tapes in a non-reactive environment.

### CROSS-REFERENCE TO RELATED APPLICATIONS

The application is a continuation of U.S. application Ser. No. 17/792,107, filed Jul. 11, 2022, which claims priority to, and the benefit of, U.S. Provisional Patent Application No. 62/961,611, filed Jan. 15, 2020, the entire contents of which are herein incorporated by reference in their entirety for all purposes.

### FIELD

The present disclosure concerns precursors to inorganic green tapes with high density, processes for using these precursors to make the green tapes with high density, and processes for using the green tapes with high density to make sintered thin films.

### BACKGROUND

Solid state ceramics, such as lithium-stuffed garnet materials and lithium borohydrides, oxides, sulfides, oxyhalides, and halides have several advantages as materials for ion-conducting electrolyte membranes and separators in a variety of electrochemical devices including fuel cells and rechargeable batteries. When compared to their liquid-based counterparts, the aforementioned solid ceramics possess safety and economic advantages as well as advantages related to the material's solid state and density which allows for correspondingly high volumetric and gravimetric energy densities when these materials are incorporated into electrochemical devices as electrolyte separators. Solid state ion conducting ceramics are well suited for solid state electrochemical devices because of their high ion conductivity properties in the solid state, their electric insulating properties, as well as their chemical compatibility with a variety of electrode materials such as lithium metal and their stability to a wide window of voltages.

Although solid state ion conducting ceramics have a series of advantageous and beneficial properties, these materials suffer from a range of issues related to forming dense green films (i.e., green tapes) and to subsequently sintering these green tapes. When solid state ion conducting ceramics are typically formulated as thin films and sintered, these films tend to stick to the substrate on which they are prepared, to crack or warp because of the processing conditions, or are too brittle post-sintering to handle and manipulate. During sintering of thin films, these films tend to crack, warp, or otherwise have surface deteriorations.

There is therefore a series of problems in the relevant field related to casting green tapes of ceramics, such as but not limited to garnets, and to sintering these green tapes to prepare high density garnet thin films. What is needed in the relevant field is, for example, improved materials and processes for casting green tapes with high density.

### SUMMARY

The instant disclosure sets forth such materials and processes, in addition to making and using the same, and other solutions to problems in the relevant field.

In one embodiment, a process for making a high density green tape is provided, the process comprising:
(a) providing a slurry comprising at least one source powder;
(b) mixing the slurry with a binder solution in a non-reactive environment;
(c) casting the slurry to form a green tape in a non-reactive environment; and
(d) drying the green tape in a non-reactive environment to achieve density >2.9 g/ml.

In certain embodiments, each non-reactive environment is unique with regard to temperature, pressure, or atmosphere composition. In certain embodiments, each non-reactive environment is the same non-reactive environment.

In some embodiments, the at least one source powder is calcined in a non-reactive environment to achieve density >4.7 g/ml as measured by geometric density. In some embodiments, the amount of the at least one source powder in the green tape is at least 50%, 55%, 55%, 60%, 65%, 70%, 80%, 85%, or 90% by weight. In some embodiments, the at least one source powder is selected from the group consisting of lithium-stuffed garnet, chemical precursors to lithium-stuffed garnet, and lithium-stuffed garnet with aluminum oxide dopants. In some embodiments, the lithium-stuffed garnet is a material selected from the group consisting of: Li_{A}La_{B}M′_{C}M″_{D}Zr_{E}O_{F}, wherein 4<A<8.5, 1.5<B<4, 0≤C≤2, 0≤D≤2; 0≤E<2.5, 10<F≤13.5, and M′ and M″ are each, independently in each instance selected from Al, Mo, W, Nb, Sb, Ca, Ba, Sr, Ce, Hf, Rb, Ga, and Ta. In some embodiments, the particle size d₅₀ is about 100 nm-200 nm, about 200 nm-300 nm, about 300 nm-400 nm, about 400 nm-500 nm, about 500 nm-600 nm, about 600 nm-700 nm, about 700 nm-800 nm, about 800 nm-900 nm, about 900 nm-1 μm, about 1 μm-2 μm, or about 2 μm-3 μm.

In some embodiments, the process further comprises milling the at least one source powder in a non-reactive environment in an anhydrous aprotic solvent. In some embodiments, the non-reactive environment comprises nitrogen gas and humidity at about −10° C. to −20° C., at about −20° C. to −30° C., at about −30° C. to −40° C., at about −40° C. to −50° C., or at about −50° C. to −60° C. dew point. In some embodiments, the non-reactive environment comprises argon gas and humidity at about −10° C. to −20° C., at about −20° C. to −30° C., at about −30° C. to −40° C., at about −40° C. to −50° C., or at about −50° C. to −60° C. dew point. In some embodiments, the aprotic solvent is selected from the group consisting of: benzene, toluene, xylene, ethyl acetate, tetrahydrofuran, dioxane, and 1,2-dimethoxyethane. In some embodiments, milling is selected from the group consisting of dry milling, attrition milling, sonication milling, high energy milling, wet milling, jet milling, and cryogenic milling. In some embodiments, the source powder is milled until it has a particle size d50 that is about 100 nm-200 nm, about 200 nm-300 nm, about 300 nm-400 nm, about 400 nm-500 nm, about 500 nm-600 nm, about 600 nm-700 nm, or about 700nm-750 nm.

In some embodiments, prior to step (c) or step (d), the process includes mixing the slurry of the modified source powder in a non-reactive environment with a binder selected from the group consisting of polypropylene (PP), atactic polypropylene (aPP), isotactic polypropylene (iPP), other polyolefins such as ethylene propylene rubber (EPR), ethylene pentene copolymer (EPC), polyisobutylene (PIB), styrene butadiene rubber (SBR), poly(ethylene-co-1-octene) (PE-co-PO), poly(ethylene-co-methylene cyclopentene) (PE-co-PMCP), stereoblock polypropylenes, polypropylene polymethyl pentene, polyethylene oxide (PEO), PEO block copolymers, silicone polymers and copolymers, polyvinyl butyral (PVB), poly(vinyl acetate) (PVAc), polyvinylpyrrolidine (PVP), poly(ethyl methacrylate) (PEMA), acrylic polymers (for example polyacrylates, polymethacrylates, and copolymers thereof), binders from the Paraloid family of resins, binders from the Butvar family of resins, binders from the Mowital family of resins, and combinations thereof. In some embodiments, milling the slurry of the modified source powder, with a dispersant selected from the group consisting of fish oil, fatty acids of degree C₈-C₂₀, alcohols of degree C₈-C₂₀, alkylamines of degree C₈-C₂₀, phosphate esters, phospholipids, olymeric dispersants such as poly(vinylpyridine), poly(ethylene imine), poly(ethylene oxide) and ethers thereof, poly(ethylene glycol) and ethers thereof, polyalkylene amine, polyacrylates, polymethacrylates, poly(vinyl alcohol), poly(vinyl acetate), polyvinyl butyral, maleic anhydride copolymers, glycolic acid ethoxylate lauryl ether, glycolic acid ethoxylate oleyl ether, sodium dodecyl sulfate, sodium dodecylbenzenesulfonate, cetyltrimethylammonium bromide, cetylpyridinium chloride, surfactants and dispersants from the Brij family of surfactants, the Triton family of surfactants, the Solsperse family of dispersants, the SMA family of dispersants, the Tween family of surfactants, and the Span family of surfactants. In some embodiments, the fatty acids of degree C₈-C₂₀ are at least one of dodecanoic acid, oleic acid, stearic acid, linolenic acid, and/or linoleic acid. As used herein, degree C₈-C₂₀ means that the described organic group includes 8 to 20 carbon atoms. In some embodiments, the alcohols of degree C₈-C₂₀ are at least one of dodecanol, oleyl alcohol, and/or stearyl alcohol. In some embodiments, the alkylamines of degree C₈-C₂₀ are at least one of dodecylamine, oleylamine, and/or stearylamine. In some embodiments, the phospholipids are phosphatidylcholine and/or lecithin. In some embodiments, the process further comprises, prior to step (c) or step (d), mixing the slurry of the source powder in a non-reactive environment with a plasticizer selected from dibutyl phthalate, dioctylphthalate, and benzyl butyl phthalate. In some embodiments, the filtration technique is selected from the group consisting of sieving, centrifugation, and separating particles of different size or different mass. In some embodiments, the slurry has a solid loading of 1 wt % to 99 wt % and wherein the solid loading refers to the amount of source powder. In some embodiments, the slurry when dried comprises the source powder at 80% wt/wt. In some embodiments, the slurry when dried comprises about 10-25% wt/wt organic content and wherein the organic content comprises slurry components other than the source powder. In some embodiments, the green tape has a density above 2.9 g/cm³ as measured by geometric density. In some embodiments, the green tape is sintered.

In some examples, including any of the foregoing, the filtration technique occurs in a non-reactive environment. In some examples, including any of the foregoing filtering, the process includes filtering the slurry in a non-reactive environment.

Some embodiments provide a free-standing green tape comprising
a. lithium-stuffed garnet particles or particles of precursors to lithium-stuffed garnet; and
b. at least one element selected from a binder, a plasticizer, a dispersant, and a surfactant.

In some embodiments, the free-standing green tape has a density of 2.9-5.0 g/cm³, a thickness of 0.5-100 μm, and a lateral extent of 0.5-400 cm². In some embodiments, the particles have a d₅₀ of about 0.1-0.2 μm, about 0.2-0.3 μm, about 0.3-0.4 μm, about 0.4-0.5 μm, about 0.5-0.6 μm, about 0.6-0.7 μm, about 0.7-0.8 μm, about 0.8-0.9 μm, about 0.9-1.0 μm, about 1.0-1.1 μm. In some embodiments, the free-standing green tape has a thickness between about 500 nm and about 100 μm. In some embodiments, green tape area is at least 0.5 cm². In some embodiments, green tape thickness varies by less than 5% over a 10 cm² area. In some embodiments, the green tape has a ceramic loading of about 50-80 vol %, a thickness of about 0.5-100 μm, and a lateral extent of about 0.5-400 cm². In some embodiments, the green tape has a ceramic loading of about 55-80 vol %, a thickness of about 0.5-100 μm, and a lateral extent of about 0.5-400 cm², a ceramic loading of about 55-75 vol %, a thickness of about 0.5-100 μm, and a lateral extent of about 0.5-400 cm², a ceramic loading of about 50-75 vol %, a thickness of about 0.5-100 μm, and a lateral extent of about 0.5-400 cm², a ceramic loading of about 55-70 vol %, a thickness of about 0.5-100 μm, and a lateral extent of about 0.5-400 cm², a ceramic loading of about 50-65 vol %, a thickness of about 0.5-100 μm, and a lateral extent of about 0.5-400 cm², or a ceramic loading of about 55-65 vol %, a thickness of about 0.5-100 μm, and a lateral extent of about 0.5-400 cm².

In some embodiments, including any of the foregoing, the green tape has a density of 2.9-5.0 g/cm³, a thickness of 0.5-100 um, and a lateral extent of 0.5-400 cm². In some embodiments, the particles have a d₅₀ of about 0.1—about 0.2 μm. In some embodiments, the particles have a d₅₀ of 0.2—about 0.3 μm. In some embodiments, the particles have a d₅₀ of 0.3—about 0.4 μm. In some embodiments, the particles have a d₅₀ of 0.4—about 0.5 μm. In some embodiments, the particles have a d₅₀ of 0.5—about 0.6 μm. In some embodiments, the particles have a d₅₀ of 0.6—about 0.7 μm. In some embodiments, the particles have a d₅₀ of 0.7—about 0.8 μm. In some embodiments, the particles have a d₅₀ of 0.8—about 0.9 μm. In some embodiments, the particles have a d₅₀ of 0.9—about 1.0 μm. In some embodiments, the particles have a d₅₀ of or 1.0—about 1.1 μm. In some embodiments, the free-standing green tape has a thickness between about 500 nm and about 100 μm. In some embodiments, the green tape area is at least 0.5 cm². In some embodiments, the green tape thickness varies by less than 5% over a 10 cm² area. In some embodiments, the green tape has a source powder solid loading of about 50—about 80 vol %, a thickness of about 0.5—about 100 um, and a lateral extent of about 0.5-400 cm². In some embodiments, the green tape has a ceramic loading of about 55—about 80 vol %, a thickness of about 0.5—about 100 um, and a lateral extent of about 0.5-400 cm². In some embodiments, the green tape has a ceramic loading of about 55—about 75 vol %, a thickness of about 0.5—about 100 um, and a lateral extent of about 0.5-400 cm². In some embodiments, the green tape has a ceramic loading of about 50—about 75 vol %, a thickness of about 0.5—about 100 um, and a lateral extent of about 0.5-400 cm². In some embodiments, the green tape has a ceramic loading of about 55—about 70 vol %, a thickness of about 0.5—about 100 um, and a lateral extent of about 0.5-400 cm². In some embodiments, the green tape has a ceramic loading of about 50—about 65 vol %, a thickness of about 0.5—about 100 um, and a lateral extent of about 0.5-400 cm². In some embodiments, the green tape has a ceramic loading of about 55—about 65 vol %, a thickness of about 0.5—about 100 um, and a lateral extent of about 0.5-400 cm².

### BRIEF DESCRIPTIONS OF THE DRAWINGS

FIG. 1 shows an example flow chart in accordance with an embodiment of the process set forth herein.

FIG. 2 shows a scanning electron microscopy (SEM) image of a green tape made by the casting process set forth in Example 1. The organic portion is labeled 201, and the lithium-stuffed garnet portion is labeled 202.

FIG. 3 shows a scanning electron microscopy (SEM) image of a sintered green tape made by Example 1. The organic portion is labeled 301, and the garnet portion is labeled 302.

FIG. 4 shows optical microscope images of a disc of green tape made by Example 1 before sintering, and the resulting disc obtained after sintering. The green tape disc is labeled 401, and the sintered disc is labeled 402.

The figures depict various embodiments of the present disclosure for purposes of illustration only. One skilled in the art will readily recognize from the following discussion that alternative embodiments of the structures and processes illustrated herein may be employed without departing from the principles described herein.

### DETAILED DESCRIPTION

The following description is presented to enable one of ordinary skill in the art to make and use the disclosed subject matter and to incorporate it in the context of applications. Various modifications, as well as a variety of uses in different applications, will be readily apparent to those skilled in the art, and the general principles defined herein may be applied to a wide range of embodiments. Thus, the present disclosure is not intended to be limited to the embodiments presented, but is to be accorded the widest scope consistent with the principles and novel features disclosed herein.

In the following detailed description, numerous specific details are set forth in order to provide a more thorough understanding of the present disclosure. However, it will be apparent to one skilled in the art that the present disclosure may be practiced without necessarily being limited to these specific details. In other instances, well-known structures and devices are shown in block diagram form, rather than in detail, in order to avoid obscuring the present disclosure.
The disclosure herein sets forth green tapes of high density prepared in a non-reactive environment, processes for making these green tapes, and processes for sintering these green tapes. The processes herein produce thin green tapes having high density when compared with green tapes prepared by conventionally known processes. Sintered films made from the green tapes have a surface which is suitable for incorporation into an electrochemical device without further processing, such as polishing or lapping. These green tapes shrink less when sintered compared to conventionally known processes. These green tapes do not warp or crack during sintering compared to conventionally known processes. These green tapes are suitable for electrochemical device applications.

### A. Definitions

As used herein, “providing” refers to the provision of, generation of, presentation of, or delivery of that which is provided. Providing includes making something available. For example, providing a powder refers to the process of making the powder available, or delivering the powder, such that the powder can be used as set forth in a process described herein. As used herein, providing also means measuring, weighing, transferring combining, or formulating.

As used herein, “casting” means to provide, deposit, or deliver a cast solution or slurry onto a substrate. Casting includes, but is not limited to, slot casting, screen printing, gravure coating, dip coating, and doctor blading.

As used herein, the phrase “slot casting,” refers to a deposition process whereby a substrate is coated, or deposited, with a solution, liquid, slurry, or the like by flowing the solution, liquid, slurry, or the like, through a slot or mold of fixed dimensions that is placed adjacent to, in contact with, or onto the substrate onto which the deposition or coating occurs. In some examples, slot casting includes a slot opening of about 1 to 100 μm.

As used herein, the phrase “dip casting” or “dip coating” refers to a deposition process whereby substrate is coated, or deposited, with a solution, liquid, slurry, or the like, by moving the substrate into and out of the solution, liquid, slurry, or the like, often in a vertical fashion.

As used herein, “casting a slurry” refers to a process wherein a slurry is deposited onto, or adhered to, a substrate. Casting can include, but is not limited to, slot casting and dip casting. As used herein, casting also includes depositing, coating, or spreading a cast solution or cast slurry onto a substrate.

As used herein, “aluminum oxide dopants” means that the lithium-stuffed garnet includes an amount of aluminum or alumina such that the empirical formula for the lithium-stuffed garnet may be written to include, for example, an amount of Al₂O₃ in addition to an amount of Li₇Zr₂La₃O₁₂, e.g., Li₇Zr₂La₃O₁₂·Al₂O₃.

As used herein the phrase “casting a film” or “casting a green tape” refers to the process of delivering or transferring a liquid or a slurry into a mold, or onto a substrate, such that the liquid or the slurry forms, or is formed into, a green tape. Casting may be done via doctor blade, Meyer rod, comma coater, gravure coater, microgravure, reverse comma coater, slot dye, slip and/or tape casting, and other processes known to those skilled in the art.

As used herein, the term “laminating” refers to the process of sequentially depositing a layer of one precursor specie, e.g., a lithium precursor specie, onto a deposition substrate and then subsequently depositing an additional layer onto an already deposited layer using a second precursor specie, e.g., a transition metal precursor specie. This laminating process can be repeated to build up several layers of deposited vapor phases. As used herein, the term “laminating” also refers to the process whereby a layer comprising an electrode, e.g., positive electrode or cathode active material comprising layer, is contacted to a layer comprising another material, e.g., garnet electrolyte. The laminating process may include a reaction or use of a binder which adheres or physically maintains the contact between the layers which are laminated. Laminating also refers to the process of bringing together unsintered, i.e. “green” ceramic films, potentially while under pressure and/or heating to join the films.

As used herein, the phrase “green tape” or “green film” refers to an unsintered tape or film including at least one member selected from garnet materials, precursors to garnet materials, binder, plasticizer, carbon, dispersant, or combinations thereof.

As used herein, the phrase “non-reactive environment” is either an environment which is at an ambient atmosphere (e.g., air or dried air) at temperature less than 30° C. and with a dew point below −40° C., or a non-reactive environment is an environment which is supplied with argon gas at temperature less than 30° C. and with a dew point below −40° C., unless stated otherwise to the contrary. Unless specified otherwise, a “non-reactive environment” is an ambient atmosphere (e.g., air or dried air) at temperature less than 30° C. and with a dew point below −10° C. and at 1 atm. A “non-reactive environment” may also include an environment in which the ambient atmosphere is at a temperature less than 100° C. and with a dew point below −10° C.; or an environment with argon gas or nitrogen gas, or a combination thereof, at a temperature less than 100° C. and with a dew point below −10° C. A non-reactive environment has a pressure of 1 atm unless specified otherwise to the contrary. Examples include a dry room, such as the commercial dry room sold by Scientific Climate Systems. Other examples include a glove box, such as that sold by MBraun.

As used herein, the phrase “thickness” or “film thickness” or “green tape thickness” refers to the distance, or median measured distance between the top and bottom faces of a green tape. As used herein, the top and bottom faces refer to the sides of the green tape having the largest surface area.

As used herein, “thin” means, when qualifying a green tape, membrane, or the like, a thickness dimension less than 200 μm, sometimes less than 100 μm and in some cases between 0.1 and 60 μm.

As used herein, the phrases “garnet precursor chemicals,” “chemical precursor to a Garnet-type electrolyte,” or “garnet chemical precursors” refer to chemicals which react to form a lithium-stuffed garnet material described herein. These chemical precursors include, but are not limited to, lithium hydroxide (e.g., LiOH), lithium oxide (e.g., Li₂O), lithium carbonate (e.g., Li₂CO₃), zirconium oxide (e.g., ZrO₂), lanthanum oxide (e.g., La₂O₃), aluminum oxide (e.g., Al₂O₃), aluminum (e.g., Al), aluminum nitrate (e.g., AlNO₃), aluminum nitrate nonahydrate, corundum, aluminum (oxy) hydroxide (gibbsite and boehmite), gallium oxide, niobium oxide (e.g., Nb₂O5), and tantalum oxide (e.g., Ta₂O₅).

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂·0.35Al₂O₃). Molar ratios are as batched unless indicated expressly to the contrary.

As used herein, the phrase “as batched,” refers to the respective molar amounts of components as initially mixed or provided at the beginning of a synthesis. For example, the formula Li₇La₃Zr₂O₁₂, as batched, means that the ratio of Li to La to Zr to O in the reagents used to make Li₇La₃Zr₂O₁₂ was 7 to 3 to 2 to 12.

As used herein, the phrase “characterized by the formula,” refers to a molar ratio of constituent atoms either as batched during the process for making that characterized material or as empirically determined.

As used herein the term “solvent,” refers to a liquid that is suitable for dissolving or solvating a component or material described herein. For example, a solvent includes a liquid, e.g., toluene, which is suitable for dissolving a component, e.g., the binder, used in the garnet sintering process.

As used herein, the term “anhydrous” refers to a substance containing less than 20 ppm water.

As used herein, the term “aprotic solvent” refers to a liquid comprising solvent molecules that do not include a labile or dissociable proton, hydronium, or hydroxyl species. An aprotic solvent molecule does not include a hydroxyl group or an amine group.

As used herein the phrase “removing a solvent,” refers to the process whereby a solvent is extracted or separated from the components or materials set forth herein. Removing a solvent includes, but is not limited to, evaporating a solvent. Removing a solvent includes, but is not limited to, using elevated temperature, a vacuum or a reduced pressure to drive off a solvent from a mixture, e.g., an unsintered green tape. In some examples, a film that includes a binder and a solvent is heated or also optionally placed in a vacuum or reduced atmosphere environment to evaporate the solvent to leave the binder, which was solvated, in the thin film after the solvent is removed.

As used herein, “green film tape” refers to a roll, continuous layer, or cut portion thereof of casted tape, either dry or not dry, which can be sintered.

As used herein, a “binder” refers to a material that assists in the adhesion of another material. For example, as used herein, polyvinyl butyral is a binder because it is useful for adhering garnet materials. Other binders may include polycarbonates. Other binders may include polyacrylates and polymethacrylates. These examples of binders are not limiting as to the entire scope of binders contemplated here but merely serve as examples. Binders useful in the present disclosure include, but are not limited to, polypropylene (PP), atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly(methylene cyclopentane) (PE-co-PMCP), poly(methyl methacrylate) (and other acrylics), acrylic, polyvinylacetacetal resin, polyvinyl butyral resin, PVB, polyvinyl acetal resin, stereoblock polypropylenes, polypropylene polymethylpentene copolymer, polyethylene oxide (PEO), PEO block copolymers, silicone, and the like.

As used here, the phrase “lithium-stuffed garnet electrolyte,” refers to oxides that are characterized by a crystal structure related to a garnet crystal structure. Lithium-stuffed garnets include compounds having the formula Li_{A}La_{B}M′_{C}M″_{D}Zr_{E}O_{F}, Li_{A}La_{B}M′_{C}M′_{D}Ta_{E}O_{F}, or Li_{A}La_{B}M′_{C}M′_{D}Nb_{E}O_{F}, wherein 4<A<8.5, 1.5<B<4, 0≤C≤2, 0≤D≤2; 0≤E<2, 10<F<13, and M′ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, Ta, V, W, Mo, Ga, or Sb and as described herein. Garnets, as used herein, also include those garnets described above that are doped with Al₂O₃. Garnets, as used herein, also include those garnets described above that are doped so that Al³⁺ substitutes for Li⁺. As used herein, lithium-stuffed garnets, and garnets, generally, include, but are not limited to, Li^{7.0}La₃(Zrₜ₁+Nbₜ₂+Taₜ₃)O₁₂+0.35Al₂O₃; wherein (t1+t2+t3=subscript 2) so that the La: (Zr/Nb/Ta) ratio is 3:2. Also, garnet used herein includes, but is not limited to, LiₓLa₃Zr₂O₁₂+yAl₂O₃, wherein x ranges from 5.5 to 9; and y ranges from 0 to 1. In some examples x is 6-7 and y is 1.0. In some examples x is 7 and y is 0.35. In some examples x is 6-7 and y is 0.7. In some examples x is 6-7 and y is 0.4. Also, garnets as used herein include, but are not limited to, LiₓLa₃Zr₂O₁₂+yAl₂O₃. Non-limiting example lithium-stuffed garnet electrolytes are found, for example, in US Patent Application Publication No. 2015-0200420 A1, which published Jul. 16, 2015.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein the phrase “garnet-type electrolyte,” refers to an electrolyte that includes a lithium-stuffed garnet material described herein as the ionic conductor. The advantages of Li-stuffed, garnet solid state electrolytes are many, including as a substitution for liquid, flammable electrolytes commonly used in lithium rechargeable batteries.

As used herein, the phrase “d₅₀ diameter” refers to the median size, in a distribution of sizes, measured by microscopy techniques or other particle size analysis techniques, such as, but not limited to, scanning electron microscopy or dynamic light scattering. D₅₀ includes the characteristic dimension at which 50% of the particles are smaller than the recited size. D₅₀ herein is calculated on a volume basis, not on a number basis.

As used herein, a particle size distribution “PSD” is measured by light scattering, for example, using on a Horiba LA-950 V2 particle size analyzer in which the solvents used for the analysis include toluene, IPA, or acetonitrile and the analysis includes a one-minute sonication before measurement.

As used herein, the phrase “d90 diameter” refers to the 90^{th} percentile size, in a distribution of sizes, measured by microscopy techniques or other particle size analysis techniques, such as, but not limited to, scanning electron microscopy or dynamic light scattering. D₉₀ includes the characteristic dimension at which 90% of the particles are smaller than the recited size. D₉₀ here is calculated on a volume basis, not on a number basis.

As used herein, the term “calcining” refers to processes involving chemical decomposition reactions or chemical reactions between solids (see Ceramic Processing and Sintering, Second Edition, M. N. Rahaman, 2005). Calcining is a different process from sintering, as used herein. Sintering involves densification and does not strive to achieve a desired phase for the material but, rather, a stable mechanical body. Sintering requires a high starting density and is typically done at higher temperatures, so-called firing temperatures. Calcining involves chemical decomposition reactions or chemical reactions between solids and not a reduction in surface free energy of consolidated particles.

As used herein the phrase “sintering the green tape,” “sintering,” or “sintering the film,” refers to a process whereby a thin green tape, as described herein, is densified (made denser, or made with a reduced porosity) through the use of heat sintering or field assisted sintering. Sintering includes the process of forming a solid mass of material by heat and/or pressure without melting it to the point of complete liquification. Sintering produces a reduction in surface free energy of consolidated particles, which can be accomplished by an atomic diffusion process that leads to densification of the body, by transporting matter from inside grains into pores or by coarsening of the microstructure, or by rearrangement of matter between different parts of pore surfaces without actually leading to a decrease in pore volumes (see Rahaman at 32).

As used herein, the term “plasticizer” refers to an additive that imparts either flexibility or plasticity to the green tape. It may be a substance or material used to increase the binder's flexibility, workability, or distensibility. Flexibility is the ability to bend without breaking. Plasticity is the ability to permanently deform.

As used herein, the phrase “stress relieving,” refers to a process which eliminates residual stress in a casted green tape during drying and associated shrinkage. One process of stress relieving includes heating the green tape at a temperature above the glass transition temperature of the organic components in the green tape to allow structural and stress rearrangement in the casted green tape to eliminate residual stress. Another process of stress relieving includes heating a casted green tape to 70° C. and holding at that temperature for a minute to allow casted green tape to relieve stress.

As used herein, a “geometric density” is calculated by dividing the mass of the green tape by its volume. The volume of the green tape is obtained from thickness and diameter measurements of the tape; or thickness, width, and length measurements. A micrometer may be used to measure thickness, while the diameter is obtained using optical microscopy. Density herein is geometric density unless expressly stated otherwise or to the contrary.

As used herein, a “pycnometry density” is measured using a Micromeritics AccuPycII 1340 Calibrate instrument. Using this instrument, a controlled amount of a powder sample is placed in a cup and its mass measured. The instrument is used to measure volume and calculate density by mass/volume.

As used herein, a green tape is considered to have high density if its density is above 2.9 g/ml.

As used herein, a green tape is considered to have low density if its density is at or below 2.6 g/ml.

As used herein, downsized garnet powder is considered to have high density if its density is above 4 g/ml.

As used herein, downsized garnet powder is considered to have low density if its density is at or below 3.6 g/ml.

As used herein, the phrase “sintering aid,” refers to an additive that is used to either lower the melting point of a liquid phase or that allows for faster sintering than otherwise would be possible without the sintering add. Sintering aids assist in the diffusion/kinetics of atoms being sintered. For example, Li₃BO₃ may be used as an additive in sintering to provides for faster or more complete densification of garnet during sintering.

As used herein, the phrase “source powder” refers to an inorganic material used in a slurry set forth herein. In some examples, the source powder is a lithium-stuffed garnet. For example, the source powder may include a powder of Li₇La₃Zr₂O₁₂·0.5Al₂O₃.

As used herein, the term “DBP” refers to the chemical having the formula C₁₆H₂₂O₄, dibutyl phthalate, having a molecular weight of 278.35 g/mol.

As used herein, the term “BBP,” refers to benzyl butyl phthalate, C₁₉H₂₀O₄, and having a molecular weight of 312.37 g/mol.

As used herein, the term “PEG,” refers to polyethylene glycol. Unless otherwise specified, the molecular weight of the PEG is from 400 to 6000 g/mol.

### B. Green Tapes

In some embodiments, the instant specification provides for improved materials and processes for casting green tapes with high density in a dry environment, which prevents the formation of low density phases such as lithium carbonates prior to the sintering step. Low density phases may be responsible for low density of ceramics, sticking and warping during sintering, and poor lithium ion conductivity of materials.

In one embodiment, the instant disclosure sets forth processes for casting a green tape, in which the processes include, generally, providing at least one source powder, calcining the powder in a non-reactive environment, milling the at least one calcined powder to prepare a slurry with aprotic solvent and a dispersant in a non-reactive environment, mixing the slurry with a binder solution in a non-reactive environment, casting the slurry to form a green tape in a non-reactive environment, drying the green tape in a non-reactive environment to achieve a high density green tape, and sintering the green tape to form a sintered thin film. In some embodiments, the process further comprises filtering the slurry in a non-reactive environment.

In a second embodiment, the instant disclosure sets forth a slurry for casting a green tape, in which the slurry includes a source powder, optionally precursors to the source powder, and at least one member selected from binders, dispersants, and solvents.

In a third embodiment, the instant disclosure sets forth a slurry for preparing a green tape, the slurry including a solvent, a source powder, and:
at least: an aprotic, anhydrous solvent selected from the group consisting of benzene, toluene, xylene, ethyl acetate, tetrahydrofuran, dioxane, and 1,2-dimethoxyethane, and;
a binder selected from the group consisting of polypropylene (PP), atactic polypropylene (aPP), isotactic polypropylene (iPP), other polyolefins such as ethylene propylene rubber (EPR), ethylene pentene copolymer (EPC), polyisobutylene (PIB), styrene butadiene rubber (SBR), poly(ethylene-co-1-octene) (PE-co-PO), poly(ethylene-co-methylene cyclopentene) (PE-co-PMCP), stereoblock polypropylenes, polypropylene polymethyl pentene, polyethylene oxide (PEO), PEO block copolymers, silicone polymers and copolymers, polyvinyl butyral (PVB), poly(vinyl acetate) (PVAc), polyvinylpyrrolidine (PVP), poly(ethyl methacrylate) (PEMA), acrylic polymers (for example polyacrylates, polymethacrylates, and copolymers thereof), binders from the Paraloid family of resins, binders from the Butvar family of resins, binders from the Mowital family of resins; a dispersant selected from the group consisting of fish oil, fatty acids of degree C8-C20 (for example, dodecanoic acid, oleic acid, stearic acid, linolenic acid, linoleic acid), alcohols of degree C8-C20 (for example, dodecanol, oleyl alcohol, stearyl alcohol), alkylamines of degree C8-C20 (for example, dodecylamine, oleylamine, stearylamine), phosphate esters, phospholipids (for example, phosphatidylcholine, lecithin), polymeric dispersants such as poly(vinylpyridine), poly(ethylene imine), poly(ethylene oxide) and ethers thereof, poly(ethylene glycol) and ethers thereof, polyalkylene amine, polyacrylates, polymethacrylates, poly(vinyl alcohol), poly(vinyl acetate), polyvinyl butyral, maleic anhydride copolymers, glycolic acid ethoxylate lauryl ether, glycolic acid ethoxylate oleyl ether, sodium dodecyl sulfate, sodium dodecylbenzenesulfonate, cetyltrimethylammonium bromide, cetylpyridinium chloride, surfactants and dispersants from the Brij family of surfactants, the Triton family of surfactants, the Solsperse family of dispersants, the SMA family of dispersants, the Tween family of surfactants, the Span family of surfactants; a plasticizer selected from the group consisting of dibutyl phthalate, dioctyl phthalate, or benzyl butyl phthalate; a source powder selected from a lithium-stuffed garnet; or a combination thereof.

In a fourth embodiment, the instant disclosure sets forth a green tape, including: a source garnet powder; a plasticizer; a binder; and a dispersant; wherein the green tape has a geometric density greater than 2.9 g/ml.

In some examples set forth herein, the green tapes cast by the processes set forth herein are high in density. These green tapes are cast from slurries made with downsized ceramic materials. They may contain refractory and/or ceramic materials that are formulated as ceramic particles intimately mixed with a binder. The purpose of this binder is, in part, to assist the sintering of the ceramic particles to result in a uniform and thin film, or layer, of refractory or ceramic post-sintering. During the sintering process, a de-bindering step removes the binder from the green tape. In some examples, this de-bindering occurs at a temperature less than 700° C., less than 450° C., less than 400° C., less than 350° C., less than 300° C., less than 250° C., or in some examples less than 200° C., or in some examples less than 150° C., or in some examples less than 100° C. During the de-bindering process, the oxygen and water partial pressures may be controlled. The de-bindering process may include multiple stages.

### C. Process of Making the Green Tape

The green tape set forth herein can be made by a variety of processes. In some processes a slurry containing a calcined source powder is prepared in a non-reactive environment using anhydrous aprotic solvents; this slurry is cast onto a substrate or a setter plate, and then this slurry is dried and sintered to prepare a dried and sintered solid ion conducting ceramic. In certain examples, the substrate may include, for example, Mylar, silicone coated Mylar, surfaces coated with polymers, surface modified polymers, or surface assembled monolayers adhered, attached, or bonded to a surface.

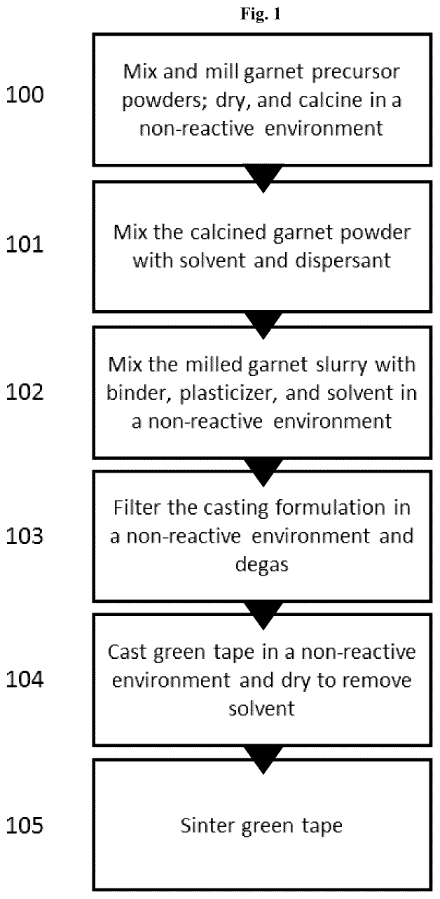

In one example, the processes set forth herein are substantially as set forth in FIG. 1. In this process, the first step 100 includes mixing, milling, drying and calcining garnet precursors. The next step 101 entails combining a solvent, dispersant, and a source powder such as garnet into a vessel in a non-reactive environment. Milling media is also added. In step 102, the combined contents are milled for 1 hour to 3 days. In the fourth step 103, a binder solution is added to the milled mixture in a non-reactive environment and mixed, and the resulting slurry is then de-aired by a de-airing process to remove gas in a non-reactive environment. In the fifth step 104, the slurry is cast by a doctor blade cast process onto a substrate (e.g., silicone coated Mylar) and dried in a non-reactive environment. In the sixth step 105, the cast green tape is sintered. Variations on this process are also considered. In one example, the slurry is filtered before casting. In one example, the casting is done with slot die, screen printing, gravure, or other casting processes.

In some examples, the green tape density as measured by Archimedes process is greater than 2.5 g/cm³. In some examples, the green tape density as measured by Archimedes process is greater than 2.6 g/cm³. In some examples, the green tape density as measured by Archimedes process is greater than 2.7 g/cm³. In some examples, the green tape density as measured by Archimedes process is greater than 2.8 g/cm³. In some examples, the green tape density as measured by Archimedes process is greater than 2.9 g/cm³. In some examples, the green tape density as measured by Archimedes process is greater than 3.0 g/cm³. In some examples, the green tape density as measured by Archimedes process is greater than 3.1 g/cm³. In some examples, the green density as measured by the geometric process is greater than 2.5 g/cm³.

In some examples, the green tape geometric density is greater than 2.3 g/cm³. In some examples, the green tape geometric density is greater than 2.4 g/cm³. In some examples, the green tape geometric density is greater than 2.5 g/cm³. In some examples, the green tape geometric density is greater than 2.6 g/cm³. In some examples, the green tape geometric density is greater than 2.7 g/cm³. In some examples, the green tape geometric density is greater than 2.8 g/cm³. In some examples, the green tape density as measured the geometric process is greater than 2.9 g/cm³. In some examples, the green tape geometric density is greater than 3.0 g/cm³. In some examples, the green tape geometric density is greater than 3.1 g/cm³.

In some examples, the green tape density as measured by Archimedes process is between 2.5 g/cm³ and 3.2 g/cm³. In some examples, the green tape density as measured by Archimedes process is between 2.6 g/cm³ and 3.2 g/cm³. In some examples, the green tape density as measured by Archimedes process is between 2.7 g/cm³ and 3.2 g/cm³. In some examples, the green tape density as measured by Archimedes process is between 2.8 g/cm³ and 3.2 g/cm³. In some examples, the green tape density as measured by Archimedes process is between 2.9 g/cm³ and 3.2 g/cm³. In some examples, the green tape density as measured by Archimedes process is between 3.0 g/cm³ and 3.2 g/cm³. In some examples, the green tape density as measured by Archimedes process is between 3.1 g/cm³ and 3.2 g/cm³.

In some examples, the green density as measured by the geometric process is between 2.5 g/cm³ and 3.2 g/cm³. In some examples, the green tape geometric density is between 2.6 g/cm³ and 3.2 g/cm³. In some examples, the green tape geometric density is between 2.7 g/cm³ and 3.2 g/cm³. In some examples, the green tape geometric density is between 2.8 g/cm³ and 3.2 g/cm³. In some examples, the green tape density as measured the geometric process is between 2.9 g/cm³ and 3.2 g/cm³. In some examples, the green tape geometric density is between 3.0 g/cm³ and 3.2 g/cm³. In some examples, the green tape geometric density is between 3.1 g/cm³ and 3.2 g/cm³.

In some embodiments, the ceramic loading (i.e., the amount of solid ceramic or source powder present in the green tape) of the green tape is greater than a certain percentage by volume after drying. In some examples, the ceramic loading of the green tape is greater than 40 vol %. In some examples, the ceramic loading of the green tape is greater than 50 vol %. In some examples, the ceramic loading of the green tape is greater than 55 vol %. In some examples, the ceramic loading of the green tape is greater than 60 vol %. In some examples, the ceramic loading of the green tape is greater than 61 vol %. In some examples, the ceramic loading of the green tape is greater than 62 vol %. In some examples, the ceramic loading of the green tape is greater than 63 vol %. In some examples, the ceramic loading of the green tape is greater than 64 vol %. In some examples, the ceramic loading of the green tape is greater than 65 vol %. In some examples, the ceramic loading of the green tape is greater than 66 vol %. In some examples, the ceramic loading of the green tape is greater than 67 vol %. In some examples, the ceramic loading of the green tape is greater than 68 vol %. In some examples, the ceramic loading of the green tape is greater than 69 vol %. In some examples, the ceramic loading of the green tape is greater than 70 vol %. In some examples, the ceramic loading of the green tape is greater than 71 vol %. In some examples, the ceramic loading of the green tape is greater than 72 vol %. In some examples, the ceramic loading of the green tape is greater than 73 vol %. In some examples, the ceramic loading of the green tape is greater than 74 vol %. In some examples, the ceramic loading of the green tape is greater than 75 vol %. In some examples, the ceramic loading of the green tape is greater than 76 vol %. In some examples, the ceramic loading of the green tape is greater than 77 vol %. In some examples, the ceramic loading of the green tape is greater than 78 vol %. In some examples, the ceramic loading of the green tape is greater than 79 vol %. In some examples, the ceramic loading of the green tape is greater than 80 vol %.

In some examples, the ceramic loading of the green tape is between 50 vol % and 80 vol %. In some examples, the ceramic loading of the green tape is between 55 vol % and 80 vol %. In some examples, the ceramic loading of the green tape is between 60 vol % and 80 vol %. In some examples, the ceramic loading of the green tape is between 61 vol % and 80 vol %. In some examples, the ceramic loading of the green tape is between 62 vol % and 80 vol %. In some examples, the ceramic loading of the green tape is between 63 vol % and 80 vol %. In some examples, the ceramic loading of the green tape is between 64 vol % and 80 vol %. In some examples, the ceramic loading of the green tape is between 65 vol % and 80 vol %. In some examples, the ceramic loading of the green tape is between 66 vol % and 80 vol %. In some examples, the ceramic loading of the green tape is between 67 vol % and 80 vol %. In some examples, the ceramic loading of the green tape is between 68 vol % and 80 vol %. In some examples, the ceramic loading of the green tape is between 69 vol % and 80 vol %. In some examples, the ceramic loading of the green tape is between 70 vol % and 80 vol %. In some examples, the ceramic loading of the green tape is between 71 vol % and 80 vol %. In some examples, the ceramic loading of the green tape is between 72 vol % and 80 vol %. In some examples, the ceramic loading of the green tape is between 73 vol % and 80 vol %. In some examples, the ceramic loading of the green tape is between 74 vol % and 80 vol %. In some examples, the ceramic loading of the green tape is between 75 vol % and 80 vol %. In some examples, the ceramic loading of the green tape is between 76 vol % and 80 vol %. In some examples, the ceramic loading of the green tape is between 77 vol % and 80 vol %. In some examples, the ceramic loading of the green tape is between 78 vol % and 80 vol %. In some examples, the ceramic loading of the green tape is between 79 vol % and 80 vol %. In some examples, the ceramic loading of the green tape is between 80 vol % and 81 vol %.

### D. Milling

In some embodiments, the processes herein include process steps related to mixing and, or, process steps related to milling. Milling includes ball milling. Milling also includes milling processes that use anhydrous solvents under non-reactive conditions such as, for example but not limited to, benzene, toluene, xylene, ethyl acetate, tetrahydrofuran, dioxane, and 1,2-dimethoxyethane, or combinations thereof.

In some examples, the milling is ball milling. In some examples, the milling is horizontal milling. In some examples, the milling is attritor milling. In some examples, the milling is immersion milling. In some examples, the milling is jet milling. In some examples, the milling is steam jet milling. In some examples, the milling is high energy milling.

In some examples, the high energy milling process results in a milled particle size distribution with d₅₀ of approximately 100 nm as measured by light scattering. In some examples, the high energy milling process is used to achieve a particle size distribution with d₅₀ of about 750 nm as measured by light scattering. In some examples, the high energy milling process is used to achieve a particle size distribution with d₅₀ of about 150 nm as measured by light scattering. In some examples, the high energy milling process is used to achieve a particle size distribution with d₅₀ of about 200 nm as measured by light scattering. In some examples, the high energy milling process is used to achieve a particle size distribution with d₅₀ of about 250 nm as measured by light scattering. In some examples, the high energy milling process is used to achieve a particle size distribution with d₅₀ of about 300 nm as measured by light scattering. In some examples, the high energy milling process is used to achieve a particle size distribution with d₅₀ of about 350 nm as measured by light scattering. In some examples, the high energy milling process is used to achieve a particle size distribution with d₅₀ of about 400 nm as measured by light scattering. In some examples, the high energy milling process is used to achieve a particle size distribution with d₅₀ of about 450 nm as measured by light scattering. In some examples, the high energy milling process is used to achieve a particle size distribution with d₅₀ of about 500 nm as measured by light scattering. In some examples, the high energy milling process is used to achieve a particle size distribution with d₅₀ of about 550 nm as measured by light scattering. In some examples, the high energy milling process is used to achieve a particle size distribution with d₅₀ of about 600 nm as measured by light scattering. In some examples, the high energy milling process is used to achieve a particle size distribution with d₅₀ of about 650 nm as measured by light scattering. In some examples, the high energy milling process is used to achieve a particle size distribution with d₅₀ of about 700 nm as measured by light scattering. In some examples, the high energy milling process is used to achieve a particle size distribution with d₅₀ of about 800 nm as measured by light scattering. In some examples, the high energy milling process is used to achieve a particle size distribution with d₅₀ of about 850 nm as measured by light scattering. In some examples, the high energy milling process is used to achieve a particle size distribution with d₅₀ of about 900 nm as measured by light scattering. In some examples, the high energy milling process is used to achieve a particle size distribution with d₅₀ of about 950 nm as measured by light scattering. In some examples, the high energy milling process is used to achieve a particle size distribution with d₅₀ of about 1000 nm as measured by light scattering.

In some examples, the aprotic solvent is tetrahydrofuran. In another example, the aprotic solvent is 1,2-dimethoxyethane. In another example, the solvent is toluene. In another example, the solvent is benzene. In another example, the solvent is xylene. In another example, the solvent is dioxane. In yet another example, the solvent is dimethyl sulfoxide. In another example, the solvent is methylene chloride. In another example, the solvent is benzene. In another example, the solvent is N-methly-2-pyrrolidone. In another example, the solvent is dimethyl formamide.

In some examples, the milling includes a high energy wet milling process with 0.3 mm Yttria stabilized zirconium oxide grinding media beads. In some examples, ball milling, horizontal milling, attritor milling, or immersion milling can be used. In some examples, using a high energy milling process produces a particle size distribution of about d₅₀~100 nm to 5000 nm.

In some examples, the milling may include a classifying step such as sieving, centrifugation, or other known laboratory of separating particles of different size and/or mass.

### E. Slurry

In some examples, the anhydrous, aprotic solvent for use with the slurries described herein includes one or more solvents selected from benzene, toluene, xylene, ethyl acetate, tetrahydrofuran, dioxane, and 1,2-dimethoxyethane, or combinations thereof optionally with one or more dispersants, optionally with one or more binders, and optionally with one or more plasticizers. In some examples, the solvent includes about 0-35% w/w anhydrous toluene. In some examples, the solvent includes about 0-35% w/w benzene. In some examples, the solvent includes about 0-35% xylene. In some examples, the solvent includes about 0-35% dioxane. In some examples, the solvent includes 0-35 % w/w tetrahydrofuran. In some examples, the solvent includes about 0-35 % w/w 1,2-dimethoxyethane. In some examples, the dispersant is 0-5 % w/w. In some examples, the binder is about 0-10 % w/w. In some examples, the plasticizer is 0-10 % w/w. In these examples, the garnet or calcined precursor materials represent the remaining % w/w (e.g., 40, 50, 60%, 70%, or 75 % w/w).

In some examples, a dispersant is used during the milling process. Examples of dispersants, include, but are not limited to, a dispersant selected from the group consisting of fish oil, fatty acids of degree C₈-C₂₀ (for example, dodecanoic acid, oleic acid, stearic acid, linolenic acid, linoleic acid), alcohols of degree C₈-C₂₀ (for example, dodecanol, oleyl alcohol, stearyl alcohol), alkylamines of degree C₈-C₂₀ (for example, dodecylamine, oleylamine, stearylamine), phosphate esters, phospholipids (for example, phosphatidylcholine, lecithin), polymeric dispersants such as poly(vinylpyridine), poly(ethylene imine), poly(ethylene oxide) and ethers thereof, poly(ethylene glycol) and ethers thereof, polyalkylene amine, polyacrylates, polymethacrylates, poly(vinyl alcohol), poly(vinyl acetate), polyvinyl butyral, maleic anhydride copolymers, glycolic acid ethoxylate lauryl ether, glycolic acid ethoxylate oleyl ether, sodium dodecyl sulfate, sodium dodecylbenzenesulfonate, cetyltrimethylammonium bromide, cetylpyridinium chloride, surfactants and dispersants from the Brij family of surfactants, the Triton family of surfactants, and the Solsperse family of dispersants, the SMA family of dispersants, the Tween family of surfactants, and the Span family of surfactants. Dispersants may be combined.

In some examples, the binders suitable for use with the slurries described herein include binders used to facilitate the adhesion between the Li-stuffed garnet particles, and include, but are not limited to, polypropylene (PP), atactic polypropylene (aPP), isotactic polypropylene (iPP), other polyolefins such as ethylene propylene rubber (EPR), ethylene pentene copolymer (EPC), polyisobutylene (PIB), styrene butadiene rubber (SBR), poly(ethylene-co-1-octene) (PE-co-PO), poly(ethylene-co-methylene cyclopentene) (PE-co-PMCP), stereoblock polypropylenes, polypropylene polymethyl pentene, polyethylene oxide (PEO), PEO block copolymers, silicone polymers and copolymers, polyvinyl butyral (PVB), poly(vinyl acetate) (PVAc), polyvinylpyrrolidine (PVP), poly(ethyl methacrylate) (PEMA), acrylic polymers (for example polyacrylates, polymethacrylates, and copolymers thereof), binders from the Paraloid family of resins, binders from the Butvar family of resins, binders from the Mowital family of resins. Binders may be combined.

In some examples, the slurry may also include a plasticizer. A non-limiting list of plasticizers includes dibutyl phthalate, dioctyl phthalate, and benzyl butyl phthalate. Plasticizers may be combined.

### F. Casting

In some processes set forth herein, the processes include casting a tape of ceramic source powder onto a substrate (e.g., porous or nonporous alumina, zirconia, garnet, alumina-zirconia, lanthanum alumina-zirconia). In some examples, the tape is prepared on a substrate such as a silicone coated substrate (e.g., silicone coated Mylar, or silicone coated Mylar on alumina).

Some tape casting processes are known in the relevant field and include those set forth in Mistler, R. E. and Twiname, E. R, Tape Casting: Theory and Practice, 1^{st} Edition Wiley-American Ceramic Society; 1 edition (Dec. 1, 2000), the entire contents of which is herein incorporated by reference in its entirety for all purposes. Other casting processes and materials as set forth in U.S. Pat. No. 5,256,609, to Dolhert, L. E., and entitled CLEAN BURNING GREEN TAPE CAST SYSTEM USING ATACTIC POLYPROPYLENE BINDER), the entire contents of which is herein incorporated by reference in its entirety for all purposes. Other casting processes include those described in D. J. Shanefield Organic Additives and Ceramic Processing, Springer Science & Business Media, (Mar. 9, 2013) which is herein incorporated by reference.

### G. Tape Drying after Casting

In some examples, the processes set forth herein include drying. In some processes, drying includes controlling the temperature of the green tape by, for example, using a heated bed on which to place or deposit casted film, infrared (IR) heating, or convection heating of casted tape. In some processes, drying may include using environmental controls such as, but not limited to, stagnant and, or, flowing environment (e.g., atmospheric air, dry air, inert gas, nitrogen gas, argon gas) to manage or to control the amount of solvent in the drying ambient. In these processes, the drying is used to control the rate of solvent removal and to ensure that the cast film dries from the substrate to the surface as opposed to from the surface to the substrate.

### H. Setter Plates

In some examples, the green tapes prepared by the processes herein, and those incorporated by reference, are sintered between setter plates. In some examples, the green tapes prepared by the processes herein, and those incorporated by reference, are sintered on at least one setter plate. In some examples, these setter plates are composed of a metal, an oxide, a nitride, or a metal, oxide, or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, nickel setter plates, aluminum (Al) setter plates, alumina setter plates, porous alumina setter plates, steel setter plates, zirconium (Zr) setter plates, zirconia setter plates, porous zirconia setter plates, lithium oxide setter plates, porous lithium oxide setter plates, lanthanum oxide setter plates, porous lanthanum oxide setter plates, garnet setter plates, porous garnet setter plates, lithium-stuffed garnet setter plates, porous lithium-stuffed garnet setter plates, and combinations thereof. In some examples, the setter plates are garnet setter plates or porous garnet setter plates. In some examples, the setter plates include an oxide material with lithium concentration greater than 5 mmol/cm³.

In some examples of the processes described herein, the setter plates and the sintering processes set forth in U.S. Patent No. US20170062873A1, entitled LITHIUM-STUFFED GARNET SETTER PLATES FOR SOLID ELECTROLYTE FABRICATION, and PCT Patent Application No. WO2016168723A1, entitled SETTER PLATES FOR SOLID ELECTROLYTE FABRICATION AND PROCESSES OF USING THE SAME TO PREPARE DENSE SOLID ELECTROLYTES, filed on Oct. 20, 2016, are incorporated herein by reference in its entirety.

In some examples, the green tapes prepared by the processes herein, and those set forth in WO 2016/168691; WO 2016/168723; US 2017/0062873; US 2017/0153060; and US 2018-0045465 A1, each of which is incorporated by reference in their entirety, are sintered between setter plates in which a metal powder is positioned between the setter plate and the green tape. In certain examples, the setter plates are selected from the group consisting of platinum (Pt) setter plates, palladium (Pd) setter plates, gold (Au) setter plates, copper (Cu) setter plates, nickel setter plates, aluminum (Al) setter plates, alumina setter plates, porous alumina setter plates, steel setter plates, zirconium (Zr) setter, zirconia setter plates, porous zirconia setter plates, lithium oxide setter plates, porous lithium oxide setter plates, lanthanum oxide setter plates, lithium zirconium oxide (Li₂ZrO₃) setter plates, lithium aluminum oxide (LiAlO₂) setter plates, porous lanthanum oxide setter plates, Lithium zirconium oxide (Li₂ZrO₃) setter plates, lithium aluminum oxide (LiAlO₂) setter plates, garnet setter plates, porous garnet setter plates, lithium-stuffed garnet setter plates, and porous lithium-stuffed garnet setter plates, and combinations of the aforementioned. In some examples, the setter plates include an oxide material with lithium concentration greater than 5mmol/cm³. In these particular examples, the metal powder is selected from Ni power, Cu powder, Au powder, Fe powder, or combinations thereof. The metal powder may additionally include ceramic material.

In some examples, the green tapes prepared by the processes herein, and those incorporated by reference, are sintered between setter plates in which a metal layer or film is positioned between the setter plate and the green tape. In some examples, these setter plates are composed of a metal, an oxide, a nitride, or a metal, oxide or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, nickel setter plates, aluminum (Al) setter plates, alumina setter plates, porous alumina setter plates, steel setter plates, zirconium (Zr), zirconia setter plates, porous zirconia setter plates, lithium oxide setter plates, porous lithium oxide setter plates, lanthanum oxide setter plates, porous lanthanum oxide setter plates, garnet setter plates, porous garnet setter plates, lithium-stuffed garnet setter plates, porous lithium-stuffed garnet setter plates, magnesia setter plates, porous magnesia setter plates. In some examples, the setter plates include an oxide material with lithium concentration greater than 5 mmol/cm³. In these particular examples, the metal powder is selected from Ni power, Cu powder, Mg powder, Mn power, Au powder, Fe powder, or combinations thereof. The metal powder may additionally include ceramic material.

During certain sintering conditions, a layer of particles (e.g., a setter sheet) or powder may be placed between the green tape and the setter plates to assist with the sintering of the green tape. As some of the green tape sinters, it tends to shrink and densify which, if not controlled, may lead to cracking or other mechanical defects in the film. In some of these examples, the layer of particles comprises a uniform layer of particles. In some other of these examples, the layer of particles comprises a uniform layer of inert, or non-reactive with the green tape, particles. In some sintering conditions, the layer of particles is provided as a sheet of particles. In some examples, the thickness of the sheet or layer or particles is about equal to the size of the particles in the sheet or layer. In other examples, the inert particles positions between the green tape and the setter plate(s) is positioned between the contact surfaces of the green tape and the parts of the green tape which are being sintered. In some continuous sintering processes, the setter plates and, or, the particles, layers, or sheets which are placed between the setter plates and the green tape, may be moved or repositioned during the sintering process so that a continuous roll of sintered film is prepared in a continuous process. In these continuous processes, the setter plates and the particles, layers, or sheets, move in conjunction with the movement of the green tape so that the portion of the green tape being sintering is in contact with the particles, layers, or sheets which are also in contact with the setter plates. In some instances, the layers or sheets are prepared with a particular weight to prevent tape warping and surface deterioration.

In some of the examples described herein, the layer or sheet of inert and, or, uniform particles (or powders) assists the sintering process by providing a minimal amount of friction between the green tape and the setter plates so that the green tape is not strained as it sinters and reduces in volume and increases in density. By reducing the friction forces, the green tape can shrink with minimal stress during the sintering process. This provides for improved sintered films that do not stick to the setter plates, which do not distort during the sintering process, and which do not crack during the sintering process or thereafter.

In some examples described herein, other setter plates may be used, for example in combination with the lithium-stuffed garnet setter plates described herein, so long as that other setter plate has a high melting point, a high lithium activity, and a stability in reducing environment. Some examples of these other materials include a member selected from Li₂ZrO₃, xLi₂O-(1-x)SiO₂ (where x=0.01-0.99), aLi₂O-bB₂O₃-cSiO₂ (where a+b+c=1), LiLaO₂, LiAlO₂, Li₂O, Li₃PO₄, a Li-stuffed garnet, or combinations thereof. Additionally, these other setter plates should not induce a chemical potential in the sintering film which results in Li diffusion out of the sintering film and into the setter plate. Additional materials include lanthanum aluminum oxide, pyrochlore and materials having a lithium concentration of greater than 0.01 mol/cm³ . In some examples, setter plates may include materials having a lithium concentration of greater than 0.02 mol/cm³. In some examples, setter plates may include materials having a lithium concentration of greater than 0.03 mol/cm³. In some examples, setter plates may include materials having a lithium concentration of greater than 0.04 mol/cm³. In some examples, setter plates may include materials having a lithium concentration of greater than 5 mmol/cm³ . In some examples, setter plates may include materials having a lithium concentration of between 10-15 mmol/cm³. In some examples, the setter material may be provided as a powder or in a non-planar shape.

### I. Sintering

The green tapes set forth herein can be sintered by sintering processes set forth in International Patent Application Publication No. WO 2015/076944, which is the published version of International Patent Application No. PCT/US2014/059578, entitled Garnet Materials for Li Secondary Batteries and Methods of Making and Using Garnet Materials, filed Oct. 7, 2014, which is incorporated by reference herein in its entirety for all purposes.

The green tapes set forth herein can be sintered in ovens open to the non-reactive environment. In some examples, the green tapes are sintered in an O₂ rich atmosphere at dew point below-40° C. In other examples, the green tapes are sintered in an argon rich atmosphere at dew point below-40° C. In yet other examples, the green tapes are sintered in an Ar/H₂ atmosphere at dew point below-40° C. In other examples, the green tapes are sintered in a nitrogen rich atmosphere at dew point below-40° C. In yet other examples, the green tapes are sintered in an N₂/H₂ atmosphere at dew point below-40° C. In other examples the green tapes are sintered in an argon/H₂O atmosphere. In some examples, the atmosphere used to sinter the green tapes is not the same as the atmosphere used to cool the film after they have been sintered.

In some examples, the process includes sintering the green tape, wherein sintering comprises heat sintering. In some of these examples, heat sintering includes heating the green tape in the range from about 700° C. to about 1200° C. for about 1 to about 600 minutes and in atmosphere having an oxygen partial pressure in the range of 1e-1 atm to 1e-15 atm.

In any of the processes set forth herein, heat sintering may include heating the green tape in the range from about 700° C. to about 1250° C.; or about 800° C. to about 1200° C.; or about 900° C. to about 1200° C.; or about 1000° C. to about 1200° C.; or about 1100° C. to about 1200° C. In any of the processes set forth herein, heat sintering can include heating the green tape in the range from about 700° C. to about 1100° C.; or about 700° C. to about 1000° C.; or about 700° C. to about 900° C.; or about 700° C. to about 800° C. In any of the processes set forth herein, heat sintering can include heating the green tape to about 700° C., about 750° C., about 850° C., about 800° C., about 900° C., about 950° C., about 1000° C., about 1050° C., about 1100° C., about 1150° C., or about 1200° C. In any of the processes set forth herein, heat sintering can include heating the green tape to 700° C., 750° C., 850° C., 800° C., 900° C., 950° C., 1000° C., 1050° C., 1100° C., 1150° C., or 1200° C. In any of the processes set forth herein, heat sintering can include heating the green tape to 700° C. In any of the processes set forth herein, heat sintering can include heating the green tape to 750° C. In any of the processes set forth herein, heat sintering can include heating the green tape to 850° C. In any of the processes set forth herein, heat sintering can include heating the green tape to 900° C. In any of the processes set forth herein, heat sintering can include heating the green tape to 950° C. In any of the processes set forth herein, heat sintering can include heating the green tape to 1000° C. In any of the processes set forth herein, heat sintering can include heating the green tape to 1050° C. In any of the processes set forth herein, heat sintering can include heating the green tape to 1100° C. In any of the processes set forth herein, heat sintering can include heating the green tape to 1125° C. In any of the processes set forth herein, heat sintering can include heating the green tape to 1150° C. In any of the processes set forth herein, heat sintering can include heating the green tape to 1200° C.

In any of the processes set forth herein, the processes may include heating the green tape for about 1 to about 600 minutes. In any of the processes set forth herein, the processes may include heating the green tape for about 20 to about 600 minutes. In any of the processes set forth herein, the processes may include heating the green tape for about 30 to about 600 minutes. In any of the processes set forth herein, the processes may include heating the green tape for about 40 to about 600 minutes. In any of the processes set forth herein, the processes may include heating the green tape for about 50 to about 600 minutes. In any of the processes set forth herein, the processes may include heating the green tape for about 60 to about 600 minutes. In any of the processes set forth herein, the processes may include heating the green tape for about 70 to about 600 minutes. In any of the processes set forth herein, the processes may include heating the green tape for about 80 to about 600 minutes. In any of the processes set forth herein, the processes may include heating the green tape for about 90 to about 600 minutes. In any of the processes set forth herein, the processes may include heating the green tape for about 100 to about 600 minutes. In any of the processes set forth herein, the processes may include heating the green tape for about 120 to about 600 minutes. In any of the processes set forth herein, the processes may include heating the green tape for about 140 to about 600 minutes. In any of the processes set forth herein, the processes may include heating the green tape for about 160 to about 600 minutes. In any of the processes set forth herein, the processes may include heating the green tape for about 180 to about 600 minutes. In any of the processes set forth herein, the processes may include heating the green tape for about 200 to about 600 minutes. In any of the processes set forth herein, the processes may include heating the green tape for about 300 to about 600 minutes. In any of the processes set forth herein, the processes may include heating the green tape for about 350 to about 600 minutes. In any of the processes set forth herein, the processes may include heating the green tape for about 400 to about 600 minutes. In any of the processes set forth herein, the processes may include heating the green tape for about 450 to about 600 minutes. In any of the processes set forth herein, the processes may include heating the green tape for about 500 to about 600 minutes. In any of the processes set forth herein, the processes may include heating the green tape for about 1 to about 500 minutes. In any of the processes set forth herein, the processes may include heating the green tape for about 1 to about 400 minutes. In any of the processes set forth herein, the processes may include heating the green tape for about 1 to about 300 minutes. In any of the processes set forth herein, the processes may include heating the green tape for about 1 to about 200 minutes. In any of the processes set forth herein, the processes may include heating the green tape for about 1 to about 100 minutes. In any of the processes set forth herein, the processes may include heating the green tape for about 1 to about 50 minutes.

In some examples, the sintering process may include sintering within a closed, but not sealed, furnace (i.e., oven, heating chamber). In some of these examples, the green tape is placed between setter plates, optionally with setter sheets or layers there between as well, and the green tape for sintering is placed next to, or in close proximity to, a sacrificial source of Li. This sacrificial source of Li helps to prevent Li loss by way of evaporation from the sintering garnet. In some examples, the closed system includes Argon gas, a mixture of Argon gas and either Hydrogen gas or water, Air, purified Air, or Nitrogen. In some of these examples, the sacrificial source of Li has a higher surface area than the surface area of the green tape which is sintered. In some examples, the Li source and the sintering green tape have the same type of lithium-stuffed garnets.

In some examples, the porosity of the green tape after firing is less than 10% by volume. In some examples, the porosity of the green tape after firing is less than 9% by volume. In some examples, the porosity of the green tape after firing is less than 8% by volume. In some examples, the porosity of the green tape after firing is less than 7% by volume. In some examples, the porosity of the green tape after firing is less than 6% by volume. In some examples, the porosity of the green tape after firing is less than 5% by volume. In some examples, the porosity of the green tape after firing is less than 4% by volume. In some examples, the porosity of the green tape after firing is less than 3% by volume. In some examples, the porosity of the green tape after firing is less than 2% by volume. In some examples, the porosity of the green tape after firing is less than 1% by volume. In some examples, the green tape porosity is determined by image analysis of cross-section FIB images.

In some embodiments, sintering instruments used included 3″ laboratory tube furnace with controlled atmosphere in the partial pressure oxygen range of 1^{e-1} to 1e⁻²⁰ atm with a custom temperature and gas flow control system.

### J. Sintering with Other Device Components

In certain examples, the green tapes are sintered while in contact with other components with which the post-sintered green tapes would be combined if used in an electrochemical device. For example, in some examples, the green tapes are layered or laminated to a positive electrode composition so that after sintering the green tape, the sintered green tape is adhered to the positive electrode. In another example, the green tape is sintered while in contact with a metallic powder (e.g., nickel (Ni) powder). As the green tape sinters, and the metal powder densifies into a solid metal foil, the sintering green tape bonds to the metal foil. The advantage of these sintering conditions is that more than one component of an electrochemical device can be prepared in one step, thus saving manufacturing time and resources.

### K. Measuring

In some embodiments, SEM Electron microscopy was performed in a Helios 600i or FEI Quanta for measurement. In some embodiments, surface roughness was measured by an optical microscope such as the Keyence VR that may measure height and calculate a roughness value. In some embodiments, powder density was measured using a pycnometer. In some embodiments, green tape density was measured using geometric process or by using Archimedes process. In some embodiments, variance in green tape thickness was measured using beta-gague, micrometer, or cross-section images.

### L. Examples

### Example 1—Process for making Calcined Lithium-Stuffed Garnet Powder

Calcined lithium-stuffed garnet powder was produced by the following series of steps. First, lithium hydroxide (LiOH), aluminum nitrate [Al(NO₃)₃9H₂O], zirconia (ZrO₂), and lanthanum oxide (La₂O₃) were massed (i.e., weighed) and mixed into a combination wherein the molar ratio of the constituent elements was Li_{7.1}Zr₂La₃O₁₂+0.5Al₂O₃. This combination was mixed and milled, using wet-milling techniques and ZrO₂ milling media, until the combination had a d₅₀ particle size of 100 nm-5 μm. Also included with the milling media was a dispersant. In some examples, also included was a solvent. The milled combination of reactants was separated from the milling media after milling to the d₅₀ particle size. The separated milled reactants were then placed in an alumina crucible and calcined in a non-reactive environment at about eight-hundred to nine-hundred degrees Celsius (900° C.) for approximately two to six hours in an oven with a controlled oxidizing atmosphere in contact with the calcining reactants. The calcination process burned and/or combusted residual solvents as well as the dispersant, and surfactant. The calcination caused the inorganic reactants to react to form the lithium-stuffed garnet. The calcined product was removed from the alumina crucibles after it cooled to room temperature in a non-reactive environment. The product was characterized by a variety of analytical techniques, including x-ray powder diffraction (XRD) and scanning electron microscopy. This product is referred to as calcined lithium-stuffed garnet and has an empirical formula of approximately was Li_{7.1}Zr₂La₃O₁₂+0.5Al₂O₃.

### Example 2—Process for making and Drying a High Density Green Tape

1000-1500 g of calcined lithium-stuffed garnet powder from Example 1 was added to 400-700 g of anhydrous aprotic solvent such as hexane, THF, or methylene chloride along with 20-45 g of oleic acid in a milling vessel in an argon glove box. The mixture was milled for 2-6 hours on a Hockmeyer mill with zirconium oxide media until the median particle size of <750 nm was measured using Horiba model LA-950 V2 at refractive index of 2.13.

200-600 g of the milled garnet slurry from the step above was mixed in a non-reactive environment. The non-reactive environment was a dry room that was at 1 atmosphere in pressure. The ambient atmosphere was dry air. The dry air had a dew point less than 10° C. A mixture of 20-45 g of Paraloid B-72 resin and 10-30 g of benzyl butyl phthalate dissolved in the same solvent used for milling was added to the milled garnet slurry in a non-reactive environment, to give a final slurry solids content of approximately 45-60 % w/w. The slurry was mixed in a FlackTek SpeedMixer for 10-30 min in a non-reactive environment. Next, a green tape was prepared by casting the mixed slurry onto a substrate by doctor blading in a non-reactive environment. The cast mixed slurry was allowed to dry in a non-reactive environment at room temperature for 2-6 hours to form a green tape. The geometric density of the dried green tape was subsequently measured to be >2.9 g/cm³.

The same work was completed in ambient air; the geometric density of the dried green tape was measured to be 2.5 g/cm³.

### Example 3—Preparation of another High Density Green Tape

This example shows a process for making another high density green tape made using different dispersant. 1000-1500 g of calcined lithium-stuffed garnet powder from Example 1 was added to 400-700 g of anhydrous aprotic solvent such as hexane, THF, or methylene chloride and 20-35 g of Solsperse M387 dispersant in a milling vessel in an argon glovebox. The mixture was milled for 2-6 hours on a Hockmeyer mill with zirconium oxide media until the median particle size of <750 nm was measured using Horiba model LA-950 V2 at refractive index of 2.13.

200-600 g of the milled garnet slurry from the step above was mixed in a non-reactive environment. A mixture of 20-45 g of Paraloid B-72 resin and 10-30 g of benzyl butyl phthalate dissolved in the same solvent used for milling was added to the milled garnet slurry in a non-reactive environment, to give a final slurry solids content of approximately 45-60 % w/w. The slurry was mixed in a FlackTek SpeedMixer for 10-30 min in a non-reactive environment. Next, a green tape was prepared by casting the mixed slurry onto a substrate by doctor blading in a non-reactive environment. The cast mixed slurry was allowed to dry in a non-reactive environment at room temperature for 2-6 hours to form a green tape.

The same work was completed in ambient air; the geometric density of the dried green tape was measured to be 2.5 g/cm³.

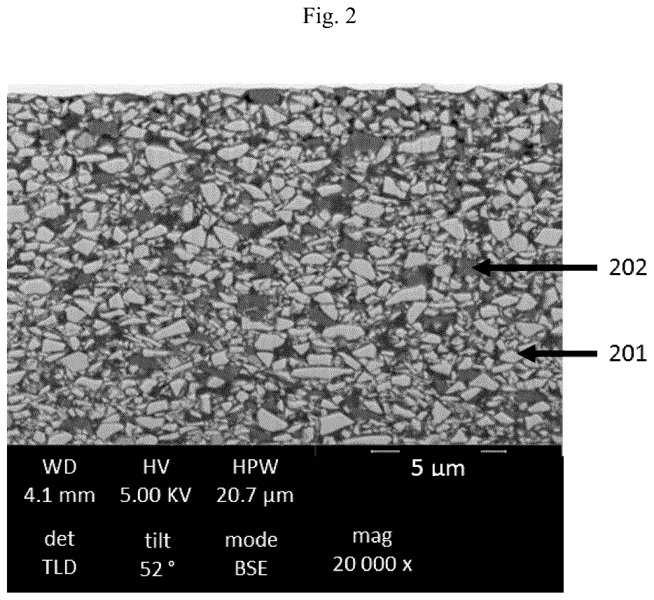

FIG. 2 shows a scanning electron microscopy (SEM) image of a green tape made by the casting processes set forth in this Example 3. The tape included 81 wt % garnet, 19 wt % organic content, and had a geometric density of 3.0g/cm³.

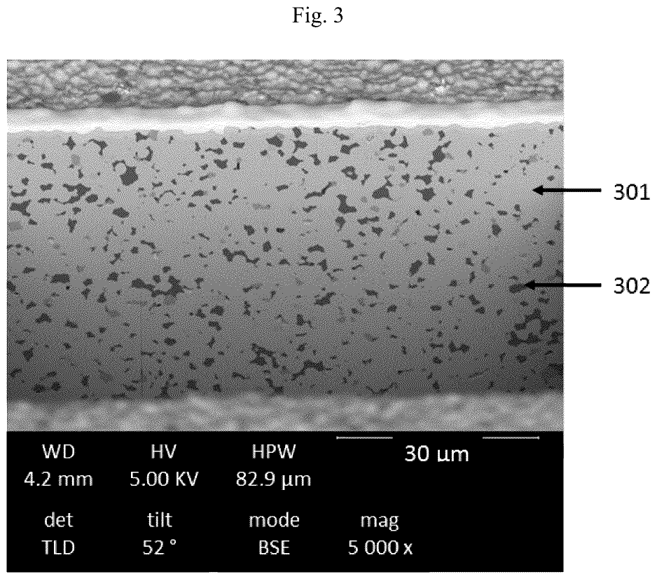

FIG. 3 shows a scanning electron microscopy (SEM) image of a sintered tape made by sintering the green tape made in Example 2. The density of the sintered green tape was measured by Archimedes process to be >4.7 g/cm³.

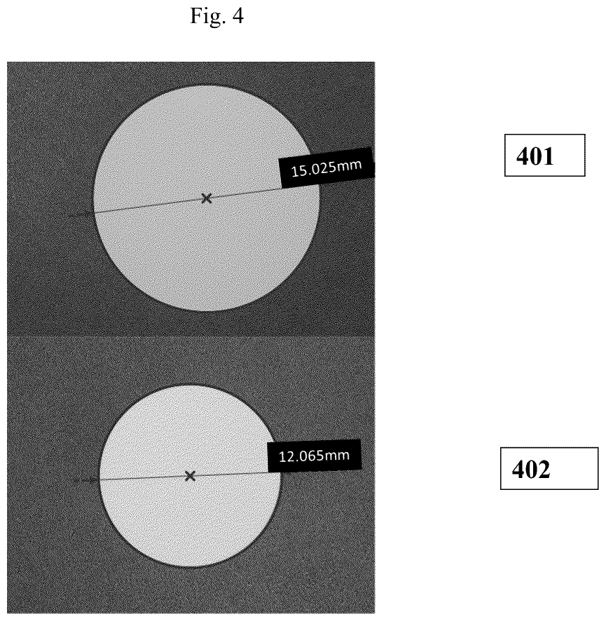

FIG. 4 shows optical microscope images of a disc of green tape made by Example 1 before sintering, and the resulting disc obtained after sintering. Shrinkage during sintering was measured as 20%, based on decrease in disc diameter. The shrinkage was 26% for a green tape that was prepared in ambient air.

### Example 4: Sintering of Green Tape

In this example, the green tape was prepared as in Example 1 or 2. In one example, multiple green tapes were stacked and laminated together. The laminated green tapes were sintered by placing them between two porous garnet setter plates, and then removed from the setter plates. The green tapes were sintered, in one example, at 1100° C. for 1-5 hours. In another example, the tapes were sintered at 1125° C. for 1-5 hours. In another example, the tapes were sintered at 1150° C. for 1-5 hours. Prior to the sintering, de-bindering was performed in Ar gas. In one example, a mixture of Ar gas and water was used for de-bindering. In another example a mixture of Ar gas and purified air was used for de-bindering. During sintering the atmosphere around the sintering green tape had a PO₂ in the range 0.5-10-20 atm.

The foregoing description of the embodiments of the disclosure has been presented for the purpose of illustration; it is not intended to be exhaustive or to limit the claims to the precise forms disclosed. Persons skilled in the relevant art can appreciate that using no more than routine experimentation, numerous equivalents, modifications and variations are possible in light of the above disclosure.

What is claimed is:

1. A process for making a high density green tape on a substrate, the process comprising:
(a) providing a slurry comprising at least one source powder;
(b) mixing the slurry with a binder solution;
(c) casting the slurry onto the substrate to form a green tape in a non-reactive environment; and
(d) drying the green tape on the substrate in a non-reactive environment to achieve a density of 2.9 g/cm³ to 5.0 g/cm³;
wherein the at least one source powder is selected from the group consisting of lithium-stuffed garnet, chemical precursors to lithium-stuffed garnet, and lithium-stuffed garnet with aluminum oxide dopants;
wherein the at least one source powder has a particle size distribution d₅₀ of 100 nm-200 nm, 200 nm-300 nm, 300 nm-400 nm, 400 nm-500 nm, 500 nm-600 nm, 600 nm-700 nm, 700 nm-800 nm, 800 nm-900 nm, 900 nm-1 μm, 1 μm-2 μm, or 2 μm-3 μm; and PCT claim 6; and
wherein the non-reactive environment comprises nitrogen gas or argon gas, or a combination thereof, and a dew point at −10° C. to −20° C., at −20° C. to −30° C., at −30° C. to −40° C., at −40° C to −50° C., or at −50° C. to −60° C.

2. The process of claim 1, wherein the at least one source powder is calcined in a non-reactive environment to achieve a geometric density greater than 4.7 g/ml.

3. The process of claim 1, wherein the amount of the at least one source powder in the green tape is at least 50%, 55%, 55%, 60%, 65%, 70%, 75%, 80%, 85%, or 90% by weight (wt %).

4. The process of claim 1, wherein the lithium-stuffed garnet is a material selected from the group consisting of: Li_{A}La_{B}M′_{C}M″_{D}Zr_{E}O_{F}, wherein 4<A<8.5, 1.5<B<4, 0≤C≤2, 0≤D≤2; 0≤E<2.5, 10<F≤13.5, and M′ and M″ are each, independently in each instance selected from Al, Mo, W, Nb, Sb, Ca, Ba, Sr, Ce, Hf, Rb, Ga, and Ta.

5. The process of claim 1, wherein the process further comprises milling the at least one source powder in an anhydrous aprotic solvent.

6. The process of claim 5, wherein aprotic solvent is selected from the group consisting of: benzene, toluene, xylene, ethyl acetate, tetrahydrofuran, dioxane, 1,2-dimethoxyethane, and combinations thereof.

7. The process of claim 1, further comprising milling the at least one source powder until the at least one source powder has a particle size distribution d₅₀ of 100 nm-200 nm, 200 nm-300 nm, 300 nm-400 nm, 400 nm-500 nm, 500 nm-600 nm, 600 nm-700 nm, or 700nm-750 nm.

8. The process of claim 7, wherein the milling is selected from the group consisting of dry milling, attrition milling, sonication milling, high energy milling, wet milling, jet milling, and cryogenic milling.

9. The process of claim 1, wherein the binder in (b) is selected from the group consisting of polypropylene (PP), atactic polypropylene (aPP), isotactic polypropylene (iPP), ethylene propylene rubber (EPR), ethylene pentene copolymer (EPC), polyisobutylene (PIB), styrene butadiene rubber (SBR), poly(ethylene-co-1-octene) (PE-co-PO), poly(ethylene-co-methylene cyclopentene) (PE-co-PMCP), stereoblock polypropylenes, polypropylene polymethyl pentene, polyethylene oxide (PEO), PEO block copolymers, silicone polymers and copolymers, polyvinyl butyral (PVB), poly(vinyl acetate) (PVAc), polyvinylpyrrolidine (PVP), poly(ethyl methacrylate) (PEMA), acrylic polymers, binders from the Paraloid family of resins, binders from the Butvar family of resins, binders from the Mowital family of resins, and combinations thereof.

10. The process of claim 1, further comprising, in (b), milling the slurry, with a dispersant selected from the group consisting of fish oil, fatty acids of degree C₈-C₂₀, alcohols of degree C₈-C₂₀, alkylamines of degree C₈-C₂₀, phosphate esters, phospholipids, polymeric dispersants such as poly(vinylpyridine), poly(ethylene imine), poly(ethylene oxide) and ethers thereof, poly(ethylene glycol) and ethers thereof, polyalkylene amine, polyacrylates, polymethacrylates, poly(vinyl alcohol), poly(vinyl acetate), polyvinyl butyral, maleic anhydride copolymers, glycolic acid ethoxylate lauryl ether, glycolic acid ethoxylate oleyl ether, sodium dodecyl sulfate, sodium dodecylbenzenesulfonate, cetyltrimethylammonium bromide, cetylpyridinium chloride, surfactants and dispersants from the Brij family of surfactants, the Triton family of surfactants, the Solsperse family of dispersants, the SMA family of dispersants, the Tween family of surfactants, and the Span family of surfactants.

11. The process of claim 10, wherein the fatty acids of degree C₈-C₂₀ are selected from dodecanoic acid, oleic acid, stearic acid, linolenic acid, and/or linoleic acid; or wherein the alcohols of degree C₈-C₂₀ are at selected from dodecanol, oleyl alcohol, stearyl alcohol, and combinations thereof; or wherein the alkylamines of degree C₈-C₂₀ are selected from dodecylamine, oleylamine, stearylamine, and combinations thereof; or wherein the phospholipids are selected from phosphatidylcholine, lecithin, and combinations thereof.

12. The process of claim 1, further comprising, prior to (c) or (d), mixing the slurry of the at least one source powder with a plasticizer selected from dibutyl phthalate, dioctyl phthalate, and benzyl butyl phthalate.

13. The process of claim 1, further comprising filtering the at least one source powder, wherein the filtration technique is selected from the group consisting of sieving, centrifugation, and separating particles of different size or different mass.

14. The process of claim 1, wherein the slurry on the substrate has a solids loading of 1 wt % to 99 wt % and wherein the solid loading refers to the amount of source powder.

15. The process of claim 1, wherein the green tape comprises particles of a lithium-stuffed garnet.

16. The process of claim 1, wherein the green tape on the substrate has a density between 2.9 g/cm³ and 3.2 cm³ as measured by geometric density.

17. The process of claim 1, wherein the green tape on the substrate has a density between 3.0 g/cm³ and 3.2 g/cm³ as measured by geometric density.

18. The process of claim 1, further comprising sintering the green tape on the substrate.

19. The process of claim 1, wherein the mixing and milling steps are in a non-reactive environment.

20. The process of claim 1, wherein the substrate is a setter plate selected from platinum (Pt) setter plates, palladium (Pd) setter plates, gold (Au) setter plates, copper (Cu) setter plates, nickel setter plates, aluminum (Al) setter plates, alumina setter plates, porous alumina setter plates, steel setter plates, zirconium (Zr) setter plates, zirconia setter plates, porous zirconia setter plates, lithium oxide setter plates, porous lithium oxide setter plates, lanthanum oxide setter plates, porous lanthanum oxide setter plates, lithium aluminum oxide (LiAlC) setter plates, Lithium zirconium oxide (LhZrOs) setter plates, and combinations thereof.
